(19) United States
(12) Patent Application Publication
(10) Pub. No.: US 2012/0141236 A1
(43) Pub. Date: Jun. 7, 2012

(54) METHOD AND STORAGE SYSTEM FOR STORING AND ORDER-PICKING ARTICLES

(76) Inventor: Erik Körner, Graz (AT)

(21) Appl. No.: 13/384,461

(22) PCT Filed: Jul. 6, 2010
(86) PCT No.: PCT/EP2010/004070

§ 371 Date: Feb. 23, 2012

(30) Foreign Application Priority Data
Jul. 17, 2009 (DE) 102009003697.4

(51) Int. Cl. B65G 1/04

(52) U.S. Cl. 414/222.01; 414/806

(57) ABSTRACT

A method and storage system (1) for storing and order-picking articles (2). The storage system (1) includes a pallet rack store (3) for storing articles supplied on introductory load carriers, an arrangement (8) for depalletizing, separating and rearranging articles between introductory load carriers and transporting load carriers (7), a rack store (4) for storing separated articles as an interim buffer store upstream of the order-picking operation, at least one order-picking station (6), in which articles are loaded onto a destination load carrier (30), and a conveying mechanism for transporting separated articles to the rack store and from the rack store to the order-picking station. Transporting load carriers (7) are used for transporting separated articles on the conveying mechanism. Separated articles (2) are stored in the rack store (4) without transporting load carriers.

### CROSS REFERENCE TO RELATED APPLICATIONS

This application is a United States National Phase application of International Application PCT/EP2010/004070 and claims the benefit of priority under 35 U.S.C. §119 of German Patent Application DE 10 2009 033 697.4 filed Jul. 17, 2009, the entire contents of which are incorporated herein by reference.

### FIELD OF THE INVENTION

The present invention pertains to a process and a storage system for storing and for commissioning articles in the form of single articles and/or packing units in a storage system comprising
a pallet bay storage for storing articles supplied on goods receiving load carriers,
a means for depalletizing, separating and re-storing articles from goods receiving load carriers to transport load carriers,
a bay storage for storing separated articles as a buffer before commissioning,
at least one commissioning station, in which articles are loaded on a targeted load carrier, and
a conveying means for transporting separated articles to the bay storage and from the bay storage to the commissioning station, whereby transport load carriers are used for transporting the separated articles to the conveying means.

### BACKGROUND OF THE INVENTION

A storage system of the above-mentioned type has become known from DE 103 13 577 B4. The prior-art storage system comprises a pallet bay storage on the goods receiving side, into which are loaded filled pallets supplied with packing units, then a means for separating supplied packing units and for re-storing the pallets on shelves, and in turn then a bay storage, to which the separated packing units are conveyed to the shelves and are loaded onto the shelves before the packing units are commissioned on the shelves, especially provided by means of a removal conveying means for loading onto order load carriers and are loaded onto the order load carriers in a defined loading sequence and are shipped. A drawback is the great expense of shelves, which are usually flat bases for the packing units in the form of trays with or without openings.

### SUMMARY OF THE INVENTION

Starting from the above-mentioned state of the art, an object of the present invention is to provide a process plus storage system for storing and for commissioning articles in the form of single articles and/or packing units, in which with simple means the storage density of the bay storage is increased and possibly a large spectrum of articles can be automatically loaded and can be retrieved for a commissioning, whereby even large quantities of articles can be effectively commissioned.

The essence of the present invention is that separated articles are stored in the bay storage without transport load carriers in a process and storage system of the type mentioned in the introduction.

The storage system has, in particular, transport load carriers with a profiling on the top side, which are preferably linear grooves open on the top.

In particular, the transport load carrier is designed as flat and without passages and preferably has an upper peripheral edge.

The means for depalletizing, separating and re-storing articles from goods receiving load carriers to transport load carriers preferably has a transfer means with a height-adjustable load pickup, whose parallel prongs can take delivery of a separated article in an upper position, on the one hand, and can be brought into a lower position in the profiling on the top side of a conveyed, positioned, empty transport load carrier, on the other hand, whereby an article moved downwards on the prongs can be placed on the positioned transport load carrier, and the transport load carrier plus the article can be conveyed to the bay storage.

The bay storage has profiled shelves and a displaceable bay storage and retrieval unit with a height-adjustable extendable and/or telescopic load pickup means, whose adjustable prongs can be brought into the profiled shelves for loading and retrieving separated articles into and out of the bay storage, on the one hand, and can be brought into the profiling on the top side of a conveyed, positioned transport load carrier, on the other hand, to transfer separated articles from the transport load carrier to the load pickup means or vice versa from load pickup means to transport load carrier.

Preferably, the load pickup means of the bay storage and retrieval unit has prongs, which can be extended on both sides of the load pickup means, to be able to operate a double bay in a bay aisle and to set up conveying paths, independent of one another, for transporting articles into or out of the bay storage.

It is especially advantageous if the article is placed in close, lateral proximity to another article on the profiled shelf of the bay storage, whereby only one set of prongs corresponding to the width of an article to be loaded or retrieved is extended in case of a load pickup means. Consequently, an even greater storage density can be established in a bay storage.

A pallet-transporting conveying means for transporting articles on pallets to and from the pallet bay storage and a transport load carrier conveying means for transporting separated articles to the transport load carriers as well as from empty transport load carriers are provided.

Furthermore, at least one commissioning station for commissioning of articles from a pallet as well as of separated articles from transport load carriers to targeted load carriers, which correspond to a commissioning order each, is provided.

The targeted load carrier may be a conveyed shipping load carrier of a respective commissioning order, which can be conveyed to the outgoing goods area after a loading in the commissioning station.

A sorting means may also be provided for preparing a sequence of pallets and transport load carriers for the sequenced preparation of articles in the commissioning station.

In particular, a pallet bay storage connected in parallel with the bay storage in prearrangement to the commissioning station, from which articles can be retrieved on pallets and can be conveyed to the commissioning station, may be provided.

The storage system according to the present invention may have a decision station, in which the decision is made whether the identified articles supplied on goods receiving load carriers shall be loaded into the pallet bay storage or into the bay storage.

The decision criterion in the decision station is preferably the turnover rate of the commissioned article and the stock of the article in the bay storage, whereby, in the case of maximum capacity utilization of the bay storage, articles are temporarily stored on pallets in the pallet bay storage and, after storage capacity becomes free in the bay storage, are re-stored separately in the bay storage after depalletizing.

The storage and commissioning system according to the present invention is especially suitable for food retail, with whose aid the branch stores of a supermarket chain can be supplied.

The storage system makes possible the storage and commissioning of articles, which are supplied on goods receiving load carriers, preferably on pallets, and are shipped on targeted load carriers, preferably roll containers or pallets.

In the storage system, the articles supplied on goods receiving load carriers are separated according to a preselection, after which they are conveyed on transport load carriers to the bay storage, and preferably a high bay, and loaded at the profiled storage site of the bay storage without load carriers, i.e., without shelves.

For a commissioning, after removal from the profiled storage site, the article is retrieved without shelves, then delivered onto a transport load carrier and transported to the commissioning area.

In the commissioning area, the articles are transferred directly from the transport load carriers to selected targeted load carriers manually or mechanically, or transferred to auxiliary load carriers preferably with height-adjustable bottoms, before they are subsequently preferably automatically transferred into a separate loading station in the outgoing goods area on targeted load carriers.

In the system, the transport load carrier is only a transport aid for the automatic transport of goods to a transport conveying means. The transport load carrier is, however, not used for storing goods at the storage site, as a result of which the system differs from prior-art systems.

The essential advantage of the present invention is that the number of load carriers for handling the articles can be markedly reduced by dispensing with load carriers during the storage of articles at the storage site of the bay storage. Therefore, all the shelves, which are necessary in the bay storage designed as shelf bay according to the state of the art mentioned in the introduction, are dispensed with.

Load carriers preferably remain after unloading of the article at the loading site of the bay storage in the preliminary zone of the bay storage and are transported on a short path to the retrieval site of the bay storage, where the empty load carriers are available again for a pickup of retrieved articles without shelves before the selected articles to be commissioned are conveyed on the (transport) load carriers to the commissioning station.

Another essential advantage of the present invention is the large storage density in the bay storage, which arises due to dispensing with load carriers during storage, since the storage spaces of the bay storage do not have to be adapted to the dimensions of the load carrier, but rather the dimensions of the article determine the size of the storage site.

Furthermore, it is advantageous that a large spectrum of articles having configurations of the widest variety, for example, bags containing feed, can be handled by the lowering technology during the loading/removal of the load carrier during use of a bay storage with profiled shelf. A large spectrum of articles can be automatically stored and then retrieved for a commissioning, whereby even large quantities of articles can be effectively commissioned, since the pallet bay storage is also available for a direct commissioning. According to the state of the art as mentioned in the introduction, the pallet bay storage is not directly available for a commissioning.

Further advantages and details of the present invention are described in detail below based on exemplary embodiments with reference to the attached drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic top view showing a storage system in the form of a goods transfer storage area;

FIG. 2 is a diagram of the essential process steps of the storage system;

FIG. 3 is a perspective view showing a transport load carrier of the storage system;

FIG. 4 is a perspective view showing a transfer means of the storage system;

FIG. 5 is a perspective view showing a bay storage of the storage system with bay storage and retrieval unit and preliminary zone for loading and retrieving articles;

FIG. 6 is a diagram of the control elements for a commissioning of articles in the storage system;

FIG. 7 is a perspective view showing the bay storage and retrieval unit with a load pickup means in four single variants; and

FIG. 8 is a perspective view showing the storage bay with bay storage and retrieval unit in four variants with a view of a loading and retrieval of articles.

### DESCRIPTION OF THE PREFERRED EMBODIMENTS

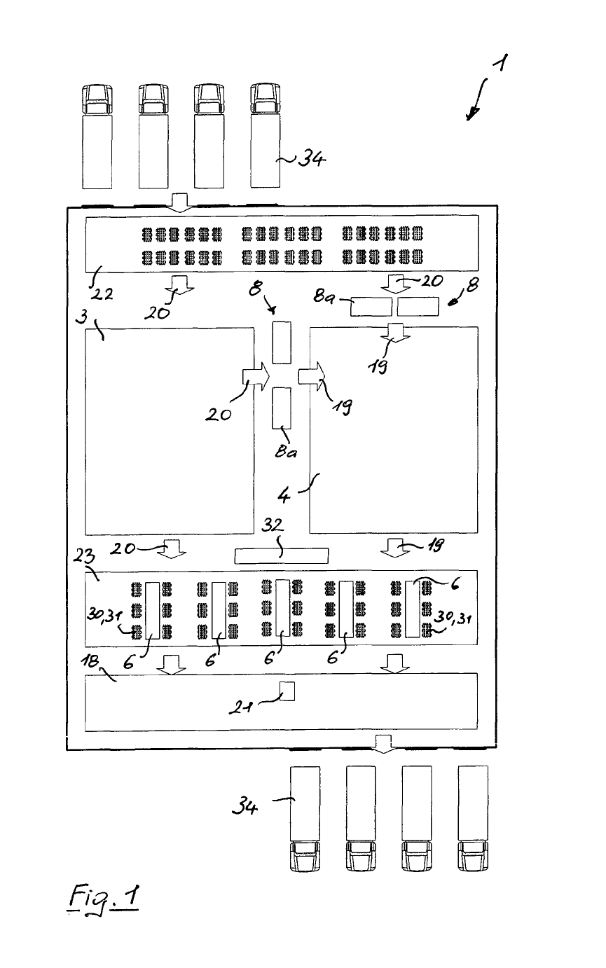

Referring to the drawings in particular, FIG. 1 schematically shows essential components of a storage system 1 in the form of a goods transfer storage area.

The storage system according to FIG. 1 comprises:
A bay storage 3 for pallets, in which articles, supplied on goods receiving load carriers, are temporarily stored in a high bay on pallets. A bay storage and retrieval unit is used for loading and retrieval.
A bay storage 4 for the storage of separated articles 2 without load carriers in a high bay. A bay storage and retrieval unit is used for loading and retrieval.
A means 8 for depalletizing, separating and re-storing articles from goods receiving load carriers to transport load carriers 7.
Commissioning stations 6 in a commissioning area 23 for commissioning articles from a pallet or transport load carriers 7 to a targeted load carrier or auxiliary load carrier.
A transport conveying means 20 for transporting pallets and a transport conveying means 19 for transporting separated articles on transport load carriers 7.

The storage system is characterized in that a transport load carrier 7, which has a profiling 11 on the top side, is used for transporting separated articles 2 on the transport conveying means 19, to be able to deliver articles 2 with a transfer means 9 on the transport load carrier 7.

Correspondingly, the bay storage 4 also has shelves 13 with a profile on the top side for the storage of articles without shelves in order to be able to feed and release articles 2 by means of a special bay storage and retrieval unit, whose load pickup means has adjustable prongs.

Within the framework of the specification, the articles denote single articles or handling or packing units (parcels, etc.).

The storage system 1 according to FIG. 1 consists of a goods receiving area 22, storage areas in the form of a pallet bay storage 3 and a bay storage 4, a commissioning area 23 with five commissioning stations 6 and an outgoing goods area 18.

The articles supplied on goods receiving load carriers by a motor vehicle 34 or train are detected in the goods receiving area 22 by a storage facility management system.

After the detection in the goods receiving area, a storage site either in the pallet bay storage 3 or bay storage 4 is assigned to an article by the storage facility management system.

In the pallet bay storage 3, the articles are stored on the goods receiving load carrier in the form of pallets, which are preferably goods receiving load carriers.

In the bay storage 4, the articles 2 are stored separately, without load carriers.

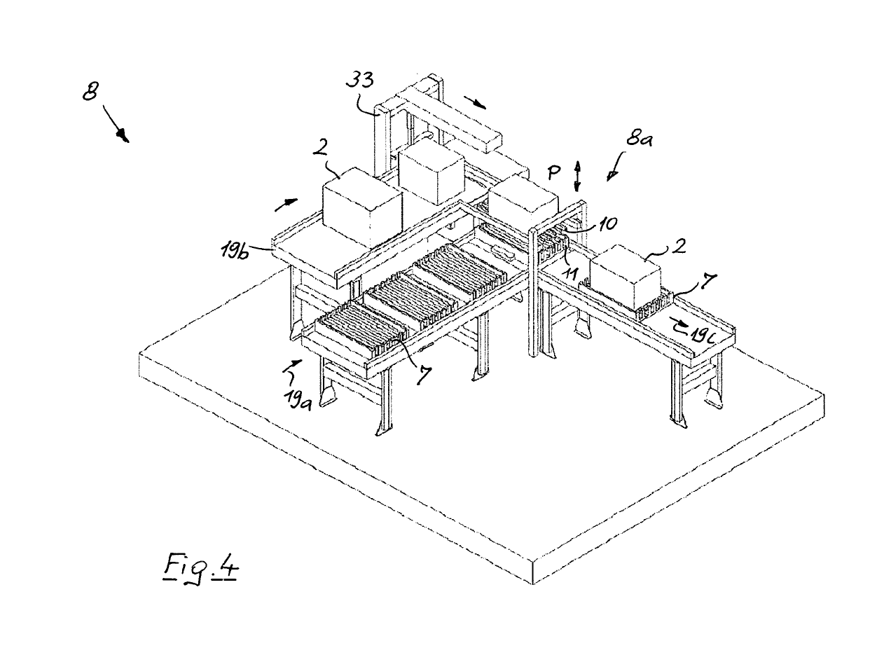

A transfer means 9 according to FIG. 4 is used to load transport load carriers 7.

In the commissioning area 23, articles 2 are re-stored on targeted load carriers in commissioning stations 6 according to commissioning orders. To this end, the articles are requested by the storage facility management system from the storage area of the pallet bay storage 3 and bay storage 4 and conveyed to the commissioning area 23.

In the outgoing goods area 18 the targeted load carriers are divided into individual shipping ramps and loaded.

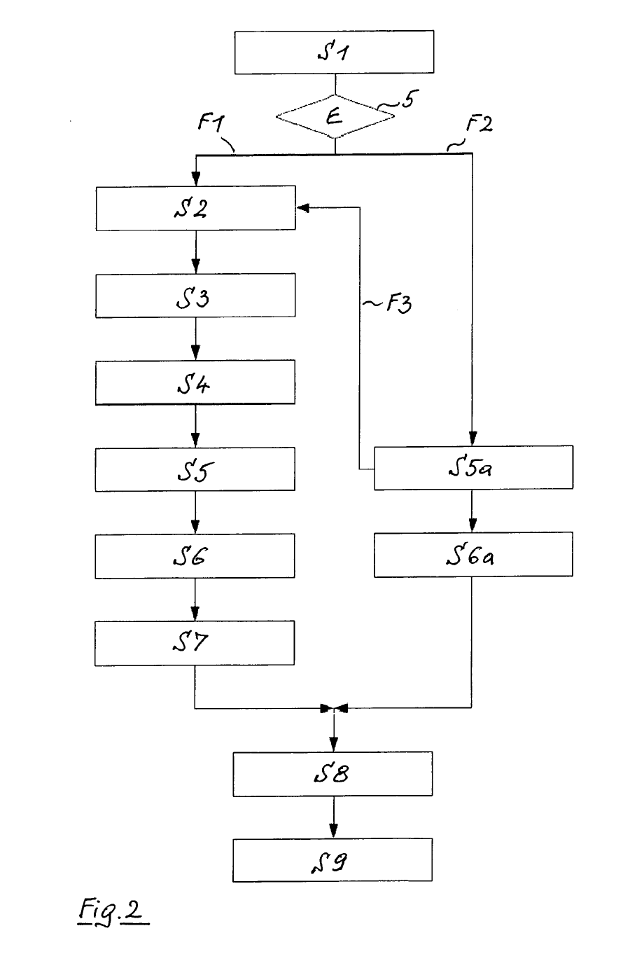

FIG. 2 shows the essential process steps in the storage and commissioning system from the supply of articles up to the distribution of the articles, whereby
Si=Goods supply on goods receiving load carriers
E=Decision in the decision station 5
S2=Depalletizing/Separating
S3=Loading of transport load carriers
S4=Transporting to the bay storage by means of transport load carriers
S5=Loading in bay storage
S5a=Loading in pallet bay storage
S6=Retrieval from bay storage
S6a=Retrieval from pallet bay storage
S7=Transporting to the commissioning area by means of transport load carriers
S8=Loading of targeted load carriers
S9=Goods distribution on targeted load carriers
   In a first step, articles are supplied with a motor vehicle 34 or train on goods receiving load carriers in the goods transfer storage area or bay system 1.

The articles are then collected by means of a storage facility management system and stored either in the pallet bay storage 3 or bay storage 4.

The decision E whether articles are stored in the pallet bay storage 3 or in the bay storage 4 depends on the turnover rate of the article and the stock of the article in the bay storage 4. Articles with a high turnover rate (high-speed turner, i.e., articles which are turned over in large quantities per time unit) are stored in the pallet bay storage 3, while articles with lower turnover rate (low-speed turner) are stored in the bay storage 4.

In the event that the stock of an article with low turnover rate has exceeded an upper limit, the article is stored in the pallet bay storage 3. If the stock of an article with low turnover rate reaches a lower limit, a supply process is initiated in order to re-store articles from the pallet bay storage 3 into the bay storage 4.

Therefore, three goods transport flows can be distinguished after the goods supply of steps S1:
A first transport flow F1, in which articles are stored in the bay storage 4.
A second transport flow F2, in which articles are stored in the pallet bay storage 3.
A third transport flow F3, in which articles are first stored in the pallet bay storage 3 and are then re-stored into the bay storage 4.

In the first transport flow F1 according to FIG. 2, after the goods supply on goods receiving load carriers, in the second step S2 according to FIG. 2 the articles are depalletized (e.g., by means of depalletizing robots with suction and gripping means) in layers according to prior-art processes and separated.

After the separating, the articles are delivered in the next step S3 on a transport load carrier 7 for the transport of the articles 1 on the conveying means 19 to the bay storage 4.

The articles on the transport load carrier are automatically delivered by means of transfer means 8a according to FIG. 4. The transport load carrier 7 is provided with an identification number in order to control the transport load carrier 7 to a defined storage site in the bay storage 4 by means of a storage control computer. In the loading of the transport load carrier 7 with an article 2, the article number is linked with the identification number by the storage control system.

Then in step S4, the article 2 is conveyed to the storage site by means of the transport load carrier 7.

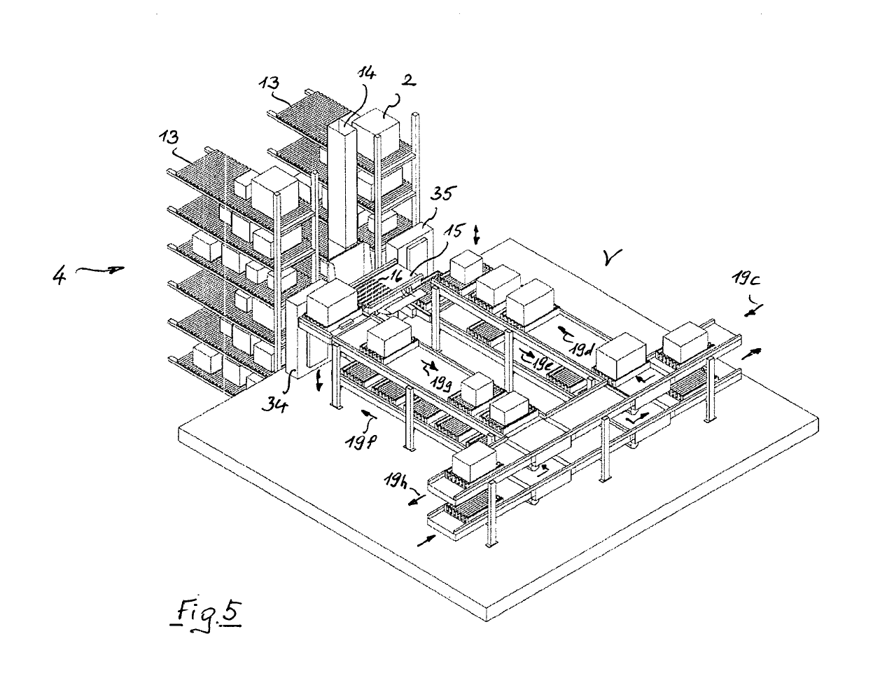

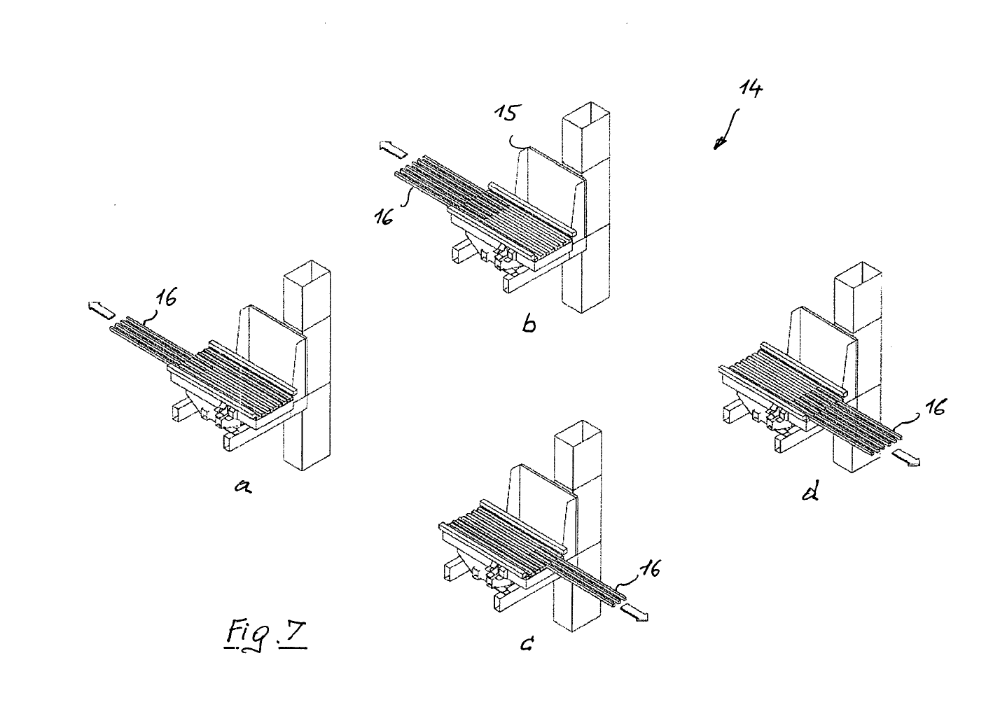

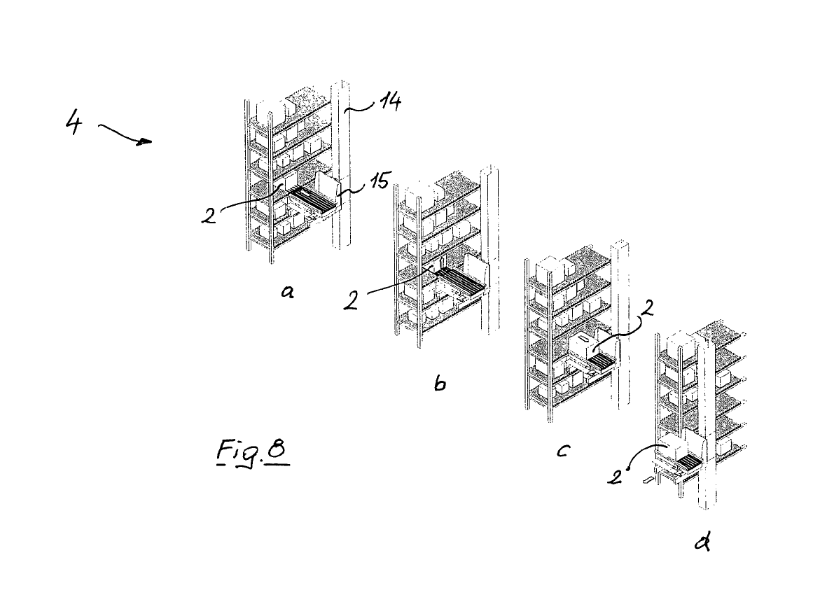

The loading in the bay storage 4 takes place in the next step S5. The bay storage 4 is designed as a high bay, into which the articles 2 are stored with the automatic bay storage and retrieval unit 14, which is controlled by the storage facility management system. For this, the article 2 is transferred from the transport load carrier 7 to the load pickup means 15 of the bay storage and retrieval unit 14 in the area of the preliminary zone V of the bay storage according to FIG. 5, on the right. The bay storage and retrieval unit 14 conveys the article 2 to the storage site, where it is stored by means of the load pickup means 15 at the storage site according to FIGS. 7 and 8.

For the commissioning of articles, articles are requested by the storage facility management system from the bay storage 4 for retrieval from the bay storage 4. The request is made depending on the quantity ordered and the availability of the articles either from the pallet bay storage 3 or from the bay storage 4.

In step S6, the articles 2 are retrieved from the bay storage 4 by means of the bay storage and retrieval unit 14. The articles are transferred in the course of the retrieval on the transport load carrier 7 for transporting on the conveying means to the commissioning area 23 according to FIG. 4 on the left.

After retrieval, transporting is carried out in the next step S7 on the conveying means by means of the transport load carriers to the commissioning area.

The commissioning at the commissioning stations follows in the next step S8. Here the articles are transferred either manually or automatically from the transport load carrier 7 to the targeted load carrier 30 or an auxiliary load carrier 31. In the automatic performance of step S8, the articles are removed by a robot from the transport load carrier 7 and distributed to one of the targeted load carriers 30 or auxiliary load carriers 31. In the manual performance of step S8, the storage facility workers remove the articles and stack them on the targeted load carrier 30 or on the auxiliary load carrier 31 in the commissioning station 6. In the exemplary embodiment according to FIG. 1, five commissioning stations are provided, each with six holding areas for targeted load carriers 30 or auxiliary load carriers 31.

After loading the targeted load carriers 30, these are distributed by means of conveying means on single shipping ramps in the outgoing goods area 18. They are then loaded onto a motor vehicle or train at the shipping ramp and delivered.

If auxiliary load carriers 31 are used, preferably a vertical shaft open at the top and at the bottom with four side walls and a height-adjustable bottom, then the storage facility worker fills the shaft from the top with simultaneous adjustment of the raised bottom downwards, whereby, after filling the shaft or auxiliary load carrier, this is transported to a loading station 21 in the outgoing goods area 18, and there, the contents or stack of articles are/is re-stored to a targeted load carrier, and preferably a roll container, before it reaches the shipping ramp and delivery.

In the second transport flow F2 according to FIG. 2, in which articles are stored in the pallet bay storage 3, the articles are stored in the pallet bay storage 3 after goods supply S1 on goods receiving load carriers in a step S5a. The loading preferably takes place with a bay storage and retrieval unit for pallets.

For the commissioning of articles in the storage area, articles are requested for retrieval from the pallet bay storage 3 by the storage facility management system.

In step S6a, the articles are retrieved from the pallet bay storage 3 by means of the bay storage and retrieval unit and transported on the goods receiving load carriers or pallets to the commissioning area 23 via the conveying means 20 according to FIG. 1, on the left.

Then in step S8, the commissioning is carried out manually by the removal of articles by a storage facility worker, who distributes the articles on individual targeted load carriers. If not all the articles are removed from the goods receiving load carrier, this is stored again in the pallet bay storage 3.

In the third transport flow F3 according to FIG. 2, first a loading in the pallet bay storage 3 takes place in step S5a. However, before the commissioning a re-storing is carried out from the pallet bay storage 3 into the bay storage 4, by retrieving articles from the pallet bay storage 3 and then by depalletizing them, separating them and reloading them on a transport load carrier 2 in order to load them in the bay storage 4 after the transport to the bay storage according to step S4.

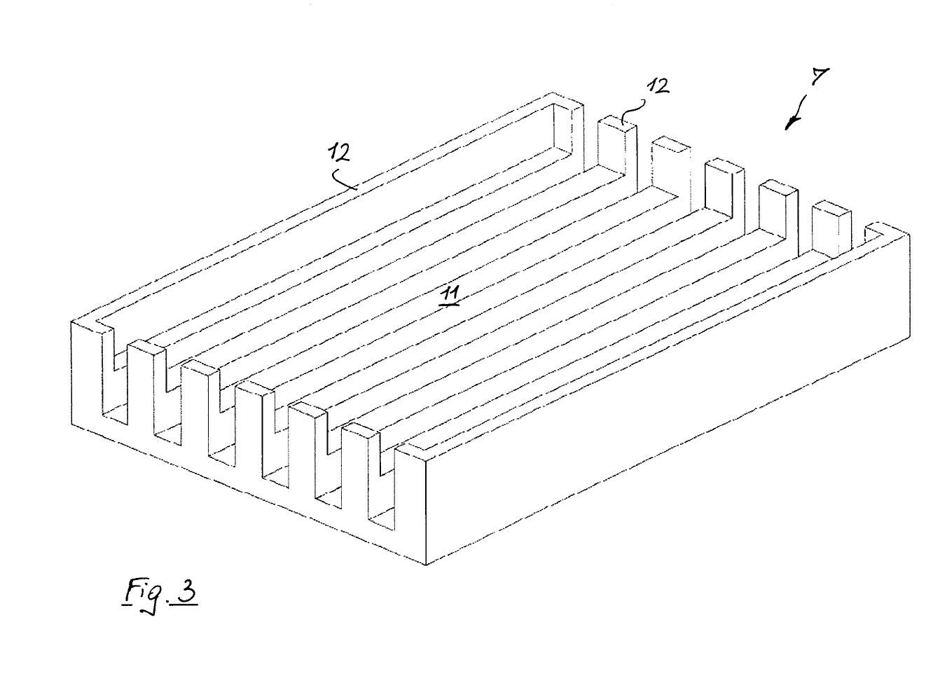

FIG. 3 illustrates a transport load carrier 7 in a special embodiment. The transport load carrier has a flat bottom for transport on the conveying means 19. The transport load carrier 7 is characterized by the profile 11 on the top side.

The profile consists of a sequence of ribs, by means of which depressions are produced for meshing with a load uptake means. The depressions extend over the entire length of the transport load carrier 7. The profiling 11 on the top side of the transport load carrier 7 especially has linear grooves, open at the top, and is designed as flat and without passages.

Moreover, the transport load carrier 7 has side walls or a peripheral wall 12 interrupted by means of the grooves or depressions in order to prevent the sliding off of the articles 2 from the transport load carrier 7.

Further, the transport load carrier 7 has a (not illustrated) lateral depression for applying a label or a transponder for the identification of the transport load carrier 7.

FIG. 4 shows the transfer means 8a for loading transport load carriers 7 with articles.

The transfer means 7 comprises a feeding conveying means 19a for empty transport load carriers 7, a feeding conveying means 19b for articles 2 and a releasing conveying means 19c, as well as a height-adjustable load pickup 10 as well as a pushing means 33.

The feeding conveying means 19b for articles 2 is placed on a plane that is higher than the feeding conveying means 19a for empty transport load carriers 7.

For loading a transport load carrier 7 with an article 2, the article is guided into a transfer position P and an empty transport load carrier 7 of the conveying means 19a is positioned under it.

The articles of the conveying means 19b are pushed over by means of the pushing means 33 onto the load pickup 10. The load pickup 10 has a forked design and is vertically displaceable.

After the transfer of the article 2 onto the load pickup 10, the load pickup is lowered vertically. Here the prongs, having a forked design, of the load pickup mesh with the depressions or the profile 11 of the empty positioned transport load carrier 7 and then transfer the article 2 onto the transport load carrier 7.

The transport load carrier 7 is then carried off on the conveying means 19c and from there reaches the preliminary zone V of the bay storage 4 according to FIG. 5.

The load pickup 10 is returned into the upper pickup position P according to FIG. 4, while a next transport load carrier 7 of the conveying means 19a is positioned under it for the pickup of a next article.

FIG. 5 shows a cutout from the bay storage 4, designed as a double bay, with a bay storage and retrieval unit 14 displaceable in a bay aisle, as well as a preliminary zone V, in which the process of re-storing an article 2 is carried out from the conveying track 19c via a feeding conveying track 19d, connected at right angles, from the transport load carrier 7 to the bay storage and retrieval unit 14 according to FIG. 5, on the right (loading), or from the bay storage and retrieval unit 14 to the empty transport load carrier 7 according to FIG. 5, on the left (retrieving).

The preliminary zone V according to FIG. 5 comprises a feeding conveying means 19d for articles 2 to be loaded and a releasing conveying means 19e lying under it for emptied transport load carriers 7 for loading articles in the bay storage 4.

The feeding conveying means 19f for empty transport load carriers and the releasing conveying means 19g for articles 2 are available for retrieving articles.

Moreover, two lifts 34, 35 are located in the area of the preliminary zone V, which adjoin the front of each half of the (double) bay storage 4.

One lift 35 is located on the loading side according to FIG. 5, on the right, the second lift 34 on the retrieval side according to FIG. 5, on the left. Both lifts 34, 35 have a lifting table, which can vertically adjust the empty transport load carriers 7, on the loading side of the feeding conveying track 19d downwards for a connection to the releasing conveying track 19e, as well as on the retrieval side of the bay storage 4 of the feeding conveying track 19f upwards for a connection to the releasing conveying track 19g. The conveying tracks 19d and 19g run parallel to one another and lie on the level of the conveying track 19c. The conveying tracks 19e and 19f run parallel to one another thereunder on the same lower level.

The loading of separated articles 2 into the bay storage 4 is described below: During loading, articles 2 are pushed over onto transport load carriers 7 of the conveying means 19c coming to the feeding conveying means 19d and guided from the conveying means 19d to a transfer position of the raised lifting table of the first lift 35, and from there pushed over onto the lifting table.

The article 2 is transferred to bay storage and retrieval unit 14 by means of the load pickup means 15 aligned on the raised lifting table. The load pickup means 15 is equipped with forked prongs 16, which are horizontally displaceable and which can lower articles, by the prongs of the load pickup means 15 being guided from the side into the depressions or the profiling 11 of the transport load carrier 7.

Thus, at the transfer position, the forked load pickup means 15 lowers the article 2 and holds it at the level of the conveying track 19d.

The article is then separated from the transport load carrier 7 by the transport load carrier 7 being lowered downwards with the first lift 35.

With a horizontal movement of the prongs of the load pickup means 15 according to FIG. 5 to the left, the article is moved into the zero position of the load pickup means and can therefore move into the bay aisle of the double bay.

The empty transport load carrier 7 is conveyed downwards with the second lift 35 and transferred to the removing conveying means 19e, which may have a (not illustrated in FIG. 5) conveying means 19f connected in parallel, to establish a short conveying path of empty transport load carriers 7 within the preliminary zone V.

The article 2, which is located on the load pickup means 15 of the bay storage and retrieval unit 14, is brought with the bay storage and retrieval unit in the bay aisle to the storage site in the bay storage 4, which was assigned to it by the storage facility management system.

The bay storage 4 is characterized by the profiled shelf 13, which has a profiling with depressions just like the transport load carrier 7. The profiled shelf 13 of each bay plane is a continuous bottom without side walls, so that no locally defined holding areas or compartments are formed. As a result, a large storage density can be achieved together with a specially designed load pickup means 16 of the bay storage and retrieval unit even when loading articles of different sizes, as will be described below.

For delivery of the article onto the shelf, the article is positioned by means of the load pickup means 15 of the bay storage and retrieval unit 14 in front of the empty shelf selected by the storage facility management system and positioned above the shelf by means of the extending prongs of the load pickup means, so that, after defined backwards movement, the prongs 16 mesh with depressions of the shelf, and as a result, the article is deposited on the top side of the shelf. Then, the extended prongs are moved back laterally out of the depressions of the shelf into the zero position of the load pickup means, whereby the deposited article remains in the bay compartment. The bay storage and retrieval unit is now available for another loading or retrieval process.

The retrieval takes place, in principle, conversely to the above-described loading: During the retrieval, an article is transported by means of the bay storage and retrieval unit from the storage site to a transfer position in the preliminary zone V.

The removal from the storage site is carried out by the load pickup means 15 of the bay storage and retrieval unit 14. The forked, horizontally displaceable components of the load pickup means 15 lower the article located at the storage site in that they mesh with the depressions of the shelf 13.

By means of a vertical lifting movement, the article is lifted from the shelf 13 and transferred to the load pickup means. The article is guided to a transfer position according to FIG. 5, on the left, by means of the bay storage and retrieval unit 14.

At the transfer position, an empty transport load carrier is provided, which is guided with the second lift 34 of the feeding conveying means 19f upwards into the transfer position, at which the article, which is transferred to the transport load carrier 7, is provided.

If the transport load carrier 7 has arrived in the transfer position, the prongs or forked, horizontally displaceable component of the load pickup means are/is pulled out of the depressions of the transport load carrier.

The article 2 is now supported on the transport load carrier 7 and is pushed over from the transfer place onto the releasing conveying means 19g.

After retrieval, the article 2 is transported by means of the transport load carrier 7 on the conveying track 19h to the commissioning area 23 according to FIG. 1.

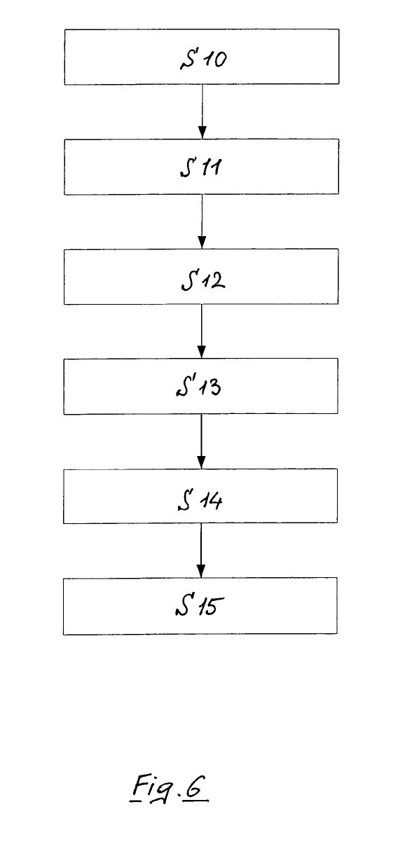

FIG. 6 shows the components of a computer system, which controls the commissioning process in the goods transfer storage area or storage system 1, wherein
S10=Detection of a commissioning order
S11=Determination of the number of targeted load carriers
S12=Determination of a loading sequence depending on articles
S13=Removal of articles from the storage bay
S14=Transport of articles to the targeted load carriers
S15=Loading of the targeted load carriers
   In a first step S10, a commissioning order is detected, namely the articles to be commissioned for a customer and the number of articles. Then, in a second step S11, the storage system 1 determines the number of targeted load carriers that are needed to deliver the articles and determines in a next step S12 the loading sequence of the targeted load carriers 3 with the articles that is needed for the sorting means 32 according to FIG. 1. Then, the computer system or storage facility management system requests articles 2 either from the bay storage 4 or the pallet bay storage 3. The system removes the articles automatically and controls them to a selected commissioning station 6 in the commissioning area 23 according to FIG. 1 in a step S14. If the articles are provided via conveying means at the commissioning station 6, the articles are re-stored on targeted load carriers 30 or auxiliary load carriers 31 by means of the system according to step S15.

FIG. 7 shows the bay storage and retrieval unit 14 displaceable in the bay aisle with a load pickup means 15 in greater detail. Load pickup means 15 is mounted in a vertically displaceable manner at a mast. The load pickup means consists of a platform, on which telescopic, extendable prongs 16 are placed. The prongs may be extended individually or in groups both to the right according to FIGS. 7c and 7d and to the left according to FIGS. 8a and 8b in order to serve both halves of the double bay or bay storage 4 according to FIG. 5.

FIG. 8 illustrates the pickup of an article 2 from the profiled shelf 13 of a bay storage 4 onto the load pickup means 15. Here, the article 2 is lowered by the meshing of the prongs 16 of the load pickup means 15 according to FIG. 7 with the profile-shaped shelf, as this is shown in FIG. 8a and has already been described above.

If the article 2 is lowered, the load pickup means is raised by means of the lift at the mast of the bay storage and retrieval unit 14 as this is shown in FIG. 8b. The article 2 is now located on the prongs 16 of the load pickup means 15.

Then, the prongs 16 of the load pickup means 15 are again moved in, so that the article is located entirely on the platform of the load pickup means 15 in the zero position, as this is shown in FIG. 8c.

The bay storage and retrieval unit 14 is then displaced in the bay aisle to transport the article into the preliminary zone V of the bay storage 4. In the preliminary zone V, the article 2 is loaded onto a transport load carrier 7, as this has already been described.

For an operation, according to FIG. 7, only so many prongs 16 are extended as are needed for the safe support of an article corresponding to its dimensions and its weight. It is especially avoided that too many unused prongs are extended laterally from the supported (large or small) article. The load pickup means 15 is designed, for example, for a small article according to FIG. 7c, for a medium-sized article according to FIG. 7a and for a large article according to FIGS. 7b and 7d. Articles of different sizes may consequently be placed in close proximity on a profiled shelf 13 of the bay storage 4, as a result of which a large storage density can be established in the bay storage 4.

Therefore, according to FIG. 1 a storage system is obviously set up for storing and commissioning articles 2 in the form of single articles and/or packing units, with a pallet bay storage, in which the supplied articles are stored on pallets, and with a bay storage, in which separated articles are stored for a commissioning, whereby storage system 1 comprises a decision station 5 with the decision E whether the identified articles supplied on goods receiving load carriers shall be stored in the pallet bay storage 3, namely a high-speed turner, or in the bay storage 4, namely a low-speed turner. The decision station 5 is a tool of the storage control computer or storage facility management system.

Furthermore, the storage system comprises a bay storage 4, and especially at least one high bay, in prearrangement to at least one commissioning station 6, in which selected articles can be loaded and retrieved without load carriers based on the decision E, whereby selected, separated articles can be conveyed on transport load carriers, which are especially profiled on the top side, to the bay storage, and from the bay storage to the commissioning station. The storage system 1 also comprises a pallet bay storage 3 connected in parallel with the bay storage 4 in prearrangement to the commissioning station(s), from which articles on pallets can be retrieved and then conveyed to the commissioning station.

While specific embodiments of the invention have been described in detail to illustrate the application of the principles of the invention, it will be understood that the invention may be embodied otherwise without departing from such principles.

1. A process for storing and commissioning articles in the form of single articles and/or packing units the storage system comprising:
providing a pallet bay storage for storing articles supplied on goods receiving load carriers;
providing a means for depalletizing, separating and re-storing articles from goods receiving load carriers to transport load carriers;
providing a bay storage for storing separated articles as a buffer before commissioning,
providing at least one commissioning station, which articles are loaded onto a targeted load carrier;
providing a conveying means for transporting separated articles to the bay storage and from the bay storage to the commissioning station, whereby transport load carriers are used for the transport of separated articles to the conveying means; and
storing separated articles in the bay storage without transport load carriers.

2. A storage system for storing and commissioning articles in the form of single articles and/or packing units, the system comprising:
a pallet bay storage for storing articles supplied on goods receiving load carriers;
a means for depalletizing, separating and re-storing articles from goods receiving load carriers to transport load carriers;
a bay storage for storing separated articles as a buffer before commissioning and without transport load carriers;
at least one commissioning station, in which articles are loaded onto a targeted load carrier;
a conveying means for transporting separated articles on transport load carriers to the bay storage and from the bay storage to the commissioning station;
a profiling on the top side of the transport load carriers.

3. A storage system in accordance with claim 2, wherein the profiling on the top side of the transport load carrier are linear grooves open at the top.

4. A storage system in accordance with claim 2, wherein the transport load carrier is designed as flat and without passages.

5. A storage system in accordance with claim 2, wherein the transport load carrier has an upper peripheral edge.

6. A storage system in accordance with claim 2, wherein the means for depalletizing, separating and re-storing articles from goods receiving load carriers to transport load carriers has a transfer means with a height-adjustable load pickup, whose parallel prongs can take delivery of a separated article in an upper position and can be brought into a lower position in the profiling on the top side of a conveyed, positioned, empty transport load carrier, whereby an article moved downwards on the prongs can be placed on the positioned transport load carrier, and the transport load carrier plus the article can be conveyed to the bay storage.

7. A storage system in accordance with claim 2, wherein the bay storage, which has profiled shelves, has a displaceable bay storage and retrieval unit with a height-adjustable, extendable and/or telescopic load pickup means, the adjustable prongs of which can be brought into the profiled shelves for loading and retrieving separated articles into and out of the bay storage and, can be brought into the profiling on the top side of a conveyed, positioned transport load carrier, to transfer separated articles from the transport load carrier to the load pickup means or vice versa from the load pickup means to the transport load carrier.

8. A storage system in accordance with claim 7, wherein the load pickup means of the bay storage and retrieval unit has prongs, which can be extended on both sides of the load pickup means.

9. A storage system in accordance with claim 7, wherein the article can be placed in close, lateral proximity to another article on the profiled shelf of the bay storage, whereby only one set of prongs corresponding to the width of an article to be loaded or retrieved is extended in case of a load pickup means.

10. A storage system in accordance with claim 2, wherein a pallet transport conveying means for transporting articles on pallets to and from the pallet bay storage and a transport load carrier conveying means for transporting separated articles to the transport load carriers as well as from empty transport load carriers are provided.

11. A storage system in accordance with claim 10, wherein the pallet transport conveying means and/or the transport load carrier conveying means are accumulatable roller or chain conveyors.

12. A storage system in accordance with claim 2,
a commissioning station for the commissioning of articles from a pallet and of separated articles from transport load carriers to targeted load carriers, which correspond to a commissioning order each.

13. A storage system in accordance with claim 12, wherein the targeted load carrier is a conveyed shipping load carrier of a corresponding commissioning order, which can be conveyed to the outgoing goods area after a loading in the commissioning station.

14. A storage system in accordance with claim 2, wherein a sorting means is provided for preparing a sequence of pallets and transport load carriers for the sequenced preparation of articles in the commissioning station.

15. A storage system in accordance with claim 2, further comprising:
a pallet bay storage connected in parallel with the bay storage in prearrangement to the commissioning station, from which articles can be retrieved from pallets and conveyed to the commissioning station.

16. A storage system in accordance with claim 15, further comprising:
a decision station for making a decision as to whether identified articles supplied on the goods receiving load carriers shall be loaded into the pallet bay storage or into bay storage.

17. A storage system in accordance with claim 16, wherein the criterion of the decision is the turnover rate of the commissioned article and the stock of the article in the bay storage, whereby, in case of maximum capacity utilization of the bay storage, articles, which are intended for the bay storage, are temporarily stored on pallets in the pallet bay storage and, after storage capacity becomes free in the bay storage, are re-stored separately in the bay storage after depalletizing.
